(19) United States
(12) Patent Application Publication
(10) Pub. No.: US 2019/0197735 A1
(43) Pub. Date: Jun. 27, 2019

(54) METHOD AND APPARATUS FOR IMAGE PROCESSING, AND ROBOT USING THE SAME

(71) Applicant: UBTECH Robotics Corp, Shenzhen (CN)

(72) Inventors: Youjun Xiong, Shenzhen (CN); Shengqi Tan, Shenzhen (CN); Cihui Pan, Shenzhen (CN); Xianji Wang, Shenzhen (CN); Jianxin Pang, Shenzhen (CN)

(21) Appl. No.: 16/205,348

(22) Filed: Nov. 30, 2018

(30) Foreign Application Priority Data
Dec. 25, 2017 (CN) 201711417358.4

(51) Int. Cl. G06T 7/80; H04N 13/271; H04N 13/257; H04N 13/246

(52) U.S. Cl. CPC G06T 7/85; H04N 13/271; H04N 13/257; G06T 2207/20076; G06T 2207/10028; G06T 2207/10024; G06T 2207/20024; H04N 13/246

(57) ABSTRACT

The present disclosure provides a method and an apparatus for image processing, and a robot using the same. The method includes: obtaining a depth map and a color map of a target object in a predetermined scene; filtering the depth map based on the color map to obtain a first depth filter map; detecting pixel values of pixels in the first depth filter map to obtain one or more first pixels, and forming a black dot cavity area based on the one or more first pixels; re-assigning a depth value of each of the one or more first pixels in the black dot cavity area according to a preset rule to obtain the depth map after repair; and filtering the depth map after repair to obtain a second depth filter map. The present disclosure is capable of improving the quality of the depth map.

### CROSS REFERENCE TO RELATED APPLICATIONS

This application claims priority to Chinese Patent Application No. 201711417358.4. filed Dec. 25, 2017, which is hereby incorporated by reference herein as if set forth in its entirety.

### BACKGROUND

### 1. Technical Field

The present disclosure relates to image processing technology, and particularly to a method and an apparatus for image processing, and a robot using the same.

### 2. Description of Related Art

Depth maps have always been a hot topic of robot vision researches, because they can be used to represent the distance of each point in a scene with respect to a camera. It makes the images on a screen full of three-dimensionality and meets the requirements to view a scene from different angles.

For service robots such as sweeping robots and driver robots, sensors are used to detect various information in the surrounding environment. Distance information such as depth information in a depth map which indicates the distance between a robot and another object in a scene is often used to implement the navigation of the robot.

However, in the prior art, the obtained depth map has problems such as rough edges and black dot cavities and generally does not have high quality, which seriously affects the effect of 3D (three-dimensional) display, and therefore affects the effect of the navigation of a robot.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a schematic block diagram of an image processing apparatus according to a first embodiment of the present disclosure.

FIG. 2 is a schematic block diagram of a robot according to a second embodiment of the present disclosure.

FIG. 3 is a flow chart of an image processing method according to a third embodiment of the present disclosure.

FIG. 4 is a flow chart of an image processing method according to a fourth embodiment of the present disclosure.

FIG. 5A is a schematic block diagram of the color of a target object obtained in an application scenario by step S201 of the image processing method of the fourth embodiment.

FIG. 5B is a schematic block diagram of the depth of the target object obtained in an application scenario by step S201 of the image processing method of the fourth embodiment.

FIG. 6A is a schematic block diagram of the target object before being filtered in step S202 of the image processing method of the fourth embodiment.

FIG. 6B is a schematic block diagram of the target object after being filtered in step S202 of the image processing method of the fourth embodiment.

FIG. 7 is a schematic block diagram of a black dot cavity area detected by step S203 of the image processing method of the fourth embodiment.

FIG. 8A is a schematic block diagram of a part of a first black dot cavity area in step S205 of the image processing method of the fourth embodiment.

FIG. 8B is a schematic block diagram of a first preset rule in step S205 of the image processing method of the fourth embodiment.

FIG. 9 is a schematic block diagram of a second preset rule in step S206 of the image processing method of the fourth embodiment.

FIG. 10 is a schematic block diagram of a depth map after repair which is obtained by step S207 according to the first preset rule and the second preset rule.

FIG. 11 is a schematic block diagram of a final output after filtering in step S208 of the image processing method of the fourth embodiment.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “a,” “an,” and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In a specific implementation, the terminal device described in the embodiments includes, but is not limited to, other portable device such as a mobile phone, a laptop computer or a tablet computer having a touch sensitive surface (e.g., a touch screen display and/or a touch pad). It should also be understood that, in some embodiments, the device may be not a portable communication device, but a desktop computer having a touch sensitive surface (e.g., a touch screen display and/or a touch pad).

In the following discussion, a terminal device including a display and a touch sensitive surface is described. However, it should be understood that, the terminal device may include one or more other physical user interface devices such as a physical keyboard, mouse, and/or joystick.

The terminal device supports various applications, such as one or more of the following: drawing application, presentation application, word processing application, website creation application, disk burning application, spreadsheet application, game application, phone applications, video conferencing applications, email applications, instant messaging applications, exercise support applications, photo management applications, digital camera applications, digital camera applications, web browsing applications, digital music player applications, and or digital video player applications.

Various applications that can be executed on the terminal device can use at least one common physical user interface device such as a touch sensitive surface, which can be used to adjust/change one or more functions between applications and/or within an application and corresponding information displayed on the terminal device. In this way, the common physical architecture of the terminal device (e.g., a touch-sensitive surface) can support a variety of applications of a user interface that is intuitive and transparent to the user.

It should be understood that, the sequence of the serial number of the steps in the embodiments does not mean the execution order while the execution order of each process should be determined by its function and internal logic, which should not be taken as any limitation to the implementation process of the embodiments.

In order to make the object, the features and the advantages of the present disclosure more obvious and easy to understand, the technical solutions in the embodiments will be clearly and completely described below in conjunction with the accompanying drawings in the embodiments. Apparently, the embodiments in the following description are merely a part of the embodiments of the present disclosure. For those skilled in the art, all other embodiments obtained according to the embodiments without creative efforts are within the scope of the present disclosure.

### Embodiment 1

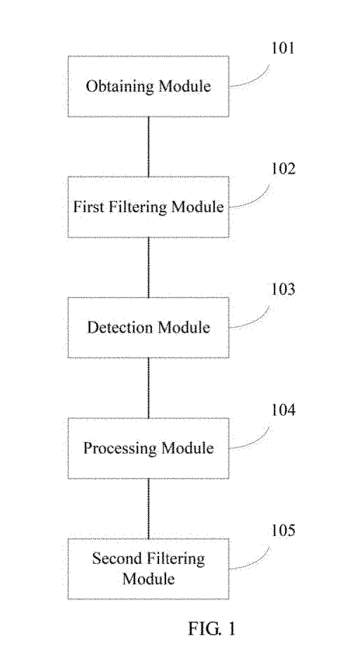

FIG. 1 is a schematic block diagram of an image processing apparatus according to a first embodiment of the present disclosure. This embodiment provides an image processing apparatus (device). The image processing apparatus may be installed on a robot with a camera. The image processing apparatus can be an independent device (e.g., a robot) or can be (integrated in) a terminal device (e.g., a smart phone or a tablet computer) or other devices with image processing capabilities. In one embodiment, the operating system of the image processing apparatus may be an iOS system, an Android system, or another operating system, which is not limited herein. For convenience of description, only parts related to this embodiment are shown.

As shown in FIG. 1, the image processing apparatus includes:

an obtaining module 101 configured to obtain a depth map and a color map of a target object in a predetermined scene;

a first filtering module 102 configured to filter the depth map basal on the color map to obtain a first depth filter map;

a detection module 103 configured to detect pixel values of pixels in the first depth filter map to find first pixels with the pixel values less than or equal to a preset value, and form a black dot cavity area based on the first pixels;

a processing module 104 configured to re-assign a depth value of each of the first pixels in the black dot cavity area according to a preset rule to obtain the depth map after repair; and

a second filtering module 105 configured to filter the depth map after repair to obtain a second depth filter map.

In one embodiment, the first filtering module 102 may include:

a first obtaining submodule configured to obtain a pixel matrix of pixels in the color map;

a second obtaining submodule configured to obtain any pixel in the pixel matrix, setting a matrix window centering on the obtained pixel, and obtaining a median value of gray values of all the pixels in the matrix window; and

a processing submodule configured to assign the median value to pixels in the depth map corresponding to the position of the obtained pixel to obtain the first depth filter map, where the positions of the pixels in the depth map are in one-to-one correspondence with the positions of the pixels in the color map.

Furthermore, the processing module 104 may include:

a dividing submodule configured to divide the black dot cavity area into a first black dot cavity area and a second black dot cavity area;

a first processing submodule configured to re-assign the depth value of each of the first pixels in the first black dot cavity area according to a first preset rule to obtain a first repaired depth map;

a second processing submodule configured to re-assign the depth value of each of the first pixels in the second black dot cavity area according to a second preset rule to obtain a second repaired depth map;

a merging submodule configured to take the first repaired depth map and the second repaired depth map as the depth map after repair;

where, the first black dot cavity area is an area where the target object is located in the depth map, and the second black dot cavity area is an area other than the first black dot cavity area in the depth map.

It should be noted that, the first preset rule is: taking any pixel in the first black dot cavity area as a starting point in the first black dot cavity area, searching for a first reference pixel along at least one direction of the surrounding of the starting point in the first black dot cavity area, comparing the depth values of the first reference pixel which is first found in each direction to obtain a minimum depth value, and assigning the minimum depth value to the starting point in the first black dot cavity area, in which the first reference pixel refers to a pixel with the pixel value larger than a first preset value; and

the second preset rule is: searching for at least a second reference pixel along a horizontal direction or a vertical direction by taking any pixel in the second black dot cavity area as a starting point in the second black dot cavity area, calculating an average value of the depth values of the found second reference pixels, and assigning the average value to the starting point in the second black dot cavity area, in which the second reference pixel refers to a pixel with the pixel value larger than a second preset value.

### Embodiment 2

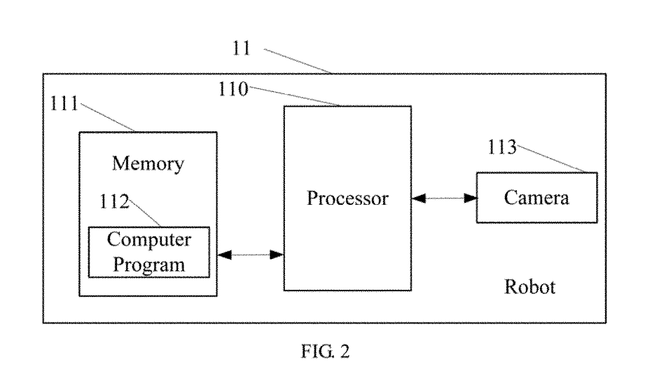

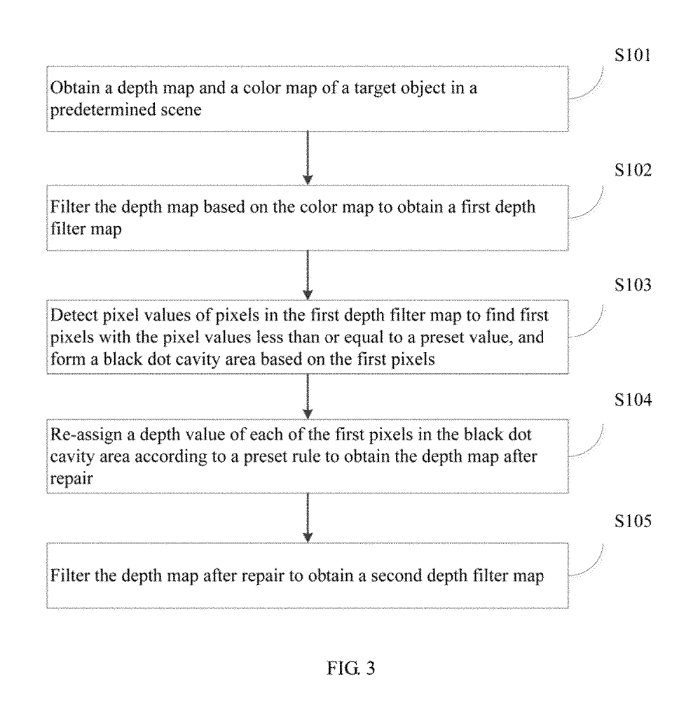

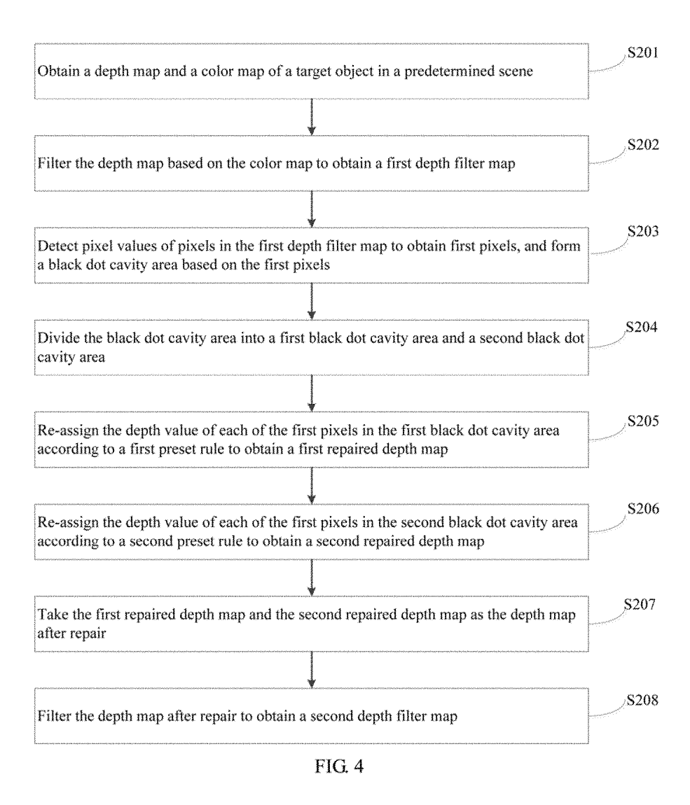

FIG. 2 is a schematic block diagram of a robot according to a second embodiment of the present disclosure. As shown in FIG. 2, the robot 11 of this embodiment includes a processor 110, a memory 111, a computer program 112 stored in the memory 111 and executable on the processor 110, which implements the steps in the above-mentioned embodiments of the image processing method, for example, steps S101-S105 shown in FIG. 3 or steps S201-S208 shown in FIG. 4, and a camera 113. Alternatively, when the processor 110 executes the (instructions in) computer program 112. the functions of each module/unit in the above-mentioned device embodiments, for example, the functions of the modules 101-105 shown in FIG. 1 are implemented. In this embodiment, the camera 113 is a binocular camera. In other embodiments, the camera 113 may be a monocular camera, or other type of camera.

Exemplarily, the computer program 112 may be divided into one or more modules/units, and the one or more modules/units are stored in the storage 61 and executed by the processor 110 to realize the present disclosure. The one or more modules/units may be a series of computer program instruction sections capable of performing a specific function, and the instruction sections are for describing the execution process of the computer program 112 in the robot 11. For example, computer program 112 can be divided into an obtaining module, a first filtering module, a detection module, a processing module, and a second filtering module, in which:

the obtaining module is configured to obtain a depth map and a color map of a target object in a predetermined scene;

the first filtering module is configured to filter the depth map based on the color map to obtain a first depth filter map;

the detection module is configured to detect pixel values of pixels in the first depth filter map to obtain first pixels, and forming a black dot cavity area based on the first pixels;

the processing module is configured to re-assign a depth value of each of the first pixels in the black dot cavity area according to a preset rule to obtain the depth map after repair; and

the second filtering module is configured to filter the depth map after repair to obtain a second depth filter map

Each of the above-mentioned modules/units may be implemented in the form of hardware (e.g., a circuit), software (e.g., a program), or a combination thereof (e.g., a circuit with a single chip microcomputer). It can be understood by those skilled in the art that FIG. 2 is merely an example of the robot 11 and does not constitute a limitation on the robot 11, and may include more or fewer components than those shown in the figure, or a combination of some components or different components. For example, the robot 11 may further include an input/output device, a network access device, a bus, and the like.

The processor 110 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor, may be a microprocessor, or the processor may also be any conventional processor.

The storage 111 may be an internal storage unit of the robot 11, for example, a hard disk or a memory of the robot 11. The storage 111 may also be an external storage device of the robot 11, for example, a plug-in hard disk, a smart media card (SMC), a secure digital (SD) card, flash card, and the like, which is equipped on the robot 11. Furthermore, the storage 111 may further include both an internal storage unit and an external storage device, of the robot 11. The storage 111 is configured to store the computer program and other programs and data required by the robot 11. The storage 111 may also be used to temporarily store data that has been or will be output.

### Embodiment 3

FIG. 3 is a flow chart of an image processing method according to a third embodiment of the present disclosure. This embodiment provides an image processing method. In this embodiment, the method is a computer-implemented method executable for a processor. The method can be applied to an image processing apparatus (device) which can be an independent device (e.g., a robot) or can be (integrated in) a terminal device (e.g., a smart phone or a tablet computer) or other devices with image processing capabilities, in which the image processing apparatus may be installed on a robot with a camera. In one embodiment, the operating system of the image processing apparatus may be an iOS system, an Android system, or another operating system, which is not limited herein. As shown in FIG. 3, the method includes the following steps.

S101: obtaining a depth map and a color map of a target object in a predetermined scene.

In one embodiment, the depth map and the color map of the target object in the predetermined scene (e.g., an indoor scene) are the depth map and the color map of the same target object in the same scene.

In this embodiment, the depth map is obtained by: searching for matched corresponding pixels in a left view image and a right view image which are after column calibration: obtaining a parallax map by calculating pixel offsets of the corresponding pixels in the left and the right view images based on a triangulation principle; and calculating depth information of the original image by using parallax information based on a projection model.

In one embodiment, in order to facilitate the calibration to the depth map and the color map, the sizes of the two should be the same. The process of the calibration may include adjusting the depth map and the color map to make the imaging origin coordinates of the depth map and the color map coincide, so that the corresponding point can be matched by only searching in the one-dimensional space in which the row of the pixels are located, where the calibration process can be implemented by adopting the relevant functions in the OpenN1 library.

It can be understood that, the above-mentioned left and right view images can be obtained in various ways. Except obtaining from different angles simultaneously through a binocular camera, the left and right view images can also be obtained from different angles at different times through a monocular camera. In an actual application, which method is actually used is mainly determined jointly by factors such as specific application requirements, viewpoint differences, lighting conditions, camera performance, and scene characteristics. In this embodiment, since the led and right view images for obtaining the depth map can be obtained by using a video camera with higher imaging quality, a camera or a terminal device with two cameras, for example: a CCD/CMOS type camera, an RGB-D type camera, or a mobile phone with two cameras.

It should be noted that, since the left and right view images obtained by the above-mentioned binocular camera are both color maps, any one of them can be used as the above-mentioned color map.

Furthermore, in the present embodiment, the left view image obtained by the above-mentioned binocular camera is taken as the color map.

It should be noted that, the depth distance of each pixel in the depth map indicates the distance between the target object and the lens in the photographed scene. However, since the target object itself has a certain size, in this embodiment, the target object is seemed as equivalent to one point.

In one embodiment, before step S101, the depth map and the color map can be obtained based on a left view image and a right view image from a camera such as a binocular camera.

S102: filtering the depth map based on the color map to obtain a first depth filter map.

In one embodiment, the filtering includes an image denoising method such as median filtering, weighted median filtering, total variation filtering, and block matching 3D filtering (BM3D).

In one embodiment, S102 may include:

obtaining a pixel matrix of pixels in the color map;

obtaining any pixel in the pixel matrix, setting a matrix window centering on the obtained pixel, and obtaining a median value of gray values of all the pixels in the matrix window; and

assigning the median value to pixel(s) in the depth map corresponding to the position of the obtained pixel to obtain the first depth filter map, where the positions of the pixels in the depth map are in one-to-one correspondence with the positions of the pixels in the color map.

After the above-mentioned median filtering, the edge of the depth map can be significantly become neat, and the amount of the smaller black dot cavities in the depth map is reduced while retaining the important geometric features of the original depth image. However, since the large black dot cavities are still not eliminated, the improvement in overall effects is not significant and therefore needs to be further processed in the subsequent process.

S103: detecting pixel values of pixels in the first depth filter map to find first pixels with the pixel values less than or equal to a preset value, and forming a black dot cavity area based on the first pixels.

In this embodiment, the preset value is 0. It can be understood that, for a grayscale image represented by an 8-bit binary number, there may be up to 2⁸=256 pixel grayscale values in the figure, that is, the grayscale value ranges front 0 to 255. Therefore, for the normal gray value, that is, the pixel values of the depth map in the present disclosure are larger than 0, while the pixel whose pixel value is less than or equal to 0 can be regarded as an abnormal pixel.

S104: re-assigning a depth value of each of the first pixels in the black dot cavity area according to a preset rule to obtain the depth map after repair.

It can be understood that, after obtaining the black dot cavity area, it is necessary to assign a reasonable depth value to all the pixels in the black dot cavity area.

Furthermore, any pixel to be repaired in the black dot cavity area is on the same object with its neighboring pixels, and the depth values of the pixels in the neighborhood are continuous.

S105: filtering the depth map after repair to obtain a second depth filter map.

In this embodiment, by filtering the depth map according to the color map. the purpose of making the edge of the depth map neat and repairing the small black dot cavities are achieved; by detecting the pixel value of the pixels in the first depth filter map, the black dot cavity area is obtained; by re-assigning the depth value of each of the first pixels in the black dot cavity area according to the preset rule, the repaired depth map is obtained; and by filtering the repaired depth map again, the second depth filter map taken as the depth map to be output is obtained. In comparison with the depth map of the prior art which without the above-mentioned processings the present disclosure is capable of improving the quality of the depth map to be processed to a certain extent, which has good practicality and ease of use.

### Embodiment 4

FIG. 4 is a flow chart of an image processing method according to a fourth embodiment of the present disclosure. This embodiment includes a further optimization of step S102 in the image processing method provided in the third embodiment and a further detailing of step S104 in the image processing method provided in the third embodiment. As shown in FIG. 4, the method includes the following steps.

S201: obtaining a depth map and a color map of a target object in a predetermined scene.

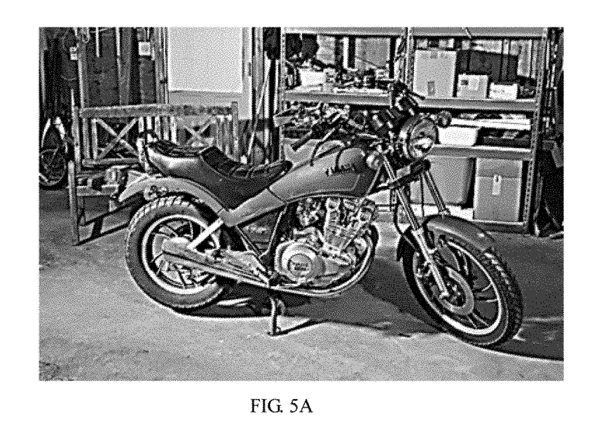

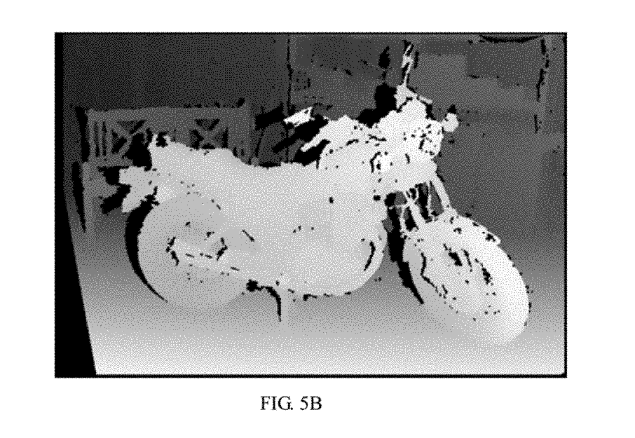

Exemplarily, a motorcycle parked indoors is used as the target object. FIG. 5A is a schematic block diagram of the color of a target object obtained in an application scenario by step S201 of the image processing method of the fourth embodiment; FIG. 5B is a schematic block diagram of the depth of the target object obtained in an application scenario by step S201 of the image processing method of the fourth embodiment. In which, FIG. 5A can be used as the preprocessed depth map in this embodiment, and FIG. 5B can be used as the corresponding color map after grayscale processing.

S202: filtering the depth map based on the color map to obtain a first depth filter map.

Furthermore, after being weighted, the median value described in step S102 of the third embodiment may be used as the pixel value of the pixels in the depth map, in which the positions of the pixels in the depth map are in one-to-one correspondence with the positions of the pixels in the color map. For example, the color map may be used as a guide map of the depth map, the pixel corresponding to the median value is marked as p, the neighboring pixel is marked as q, and the pixel in the depth map corresponding to the point p in the above-mentioned guide map is marked as p′, and then the weighting coefficient w(p,q) between the pixel p and the pixel q is calculated according to the following formula (1) and substituted into the following formula (2) to calculate the final weighted median value h(p,i), that is, the pixel value of the pixels in the filtered depth map:

$$\begin{matrix}w ( p , q ) = exp ( - \frac{{\vert {I}_{p} - {I}_{q} \vert}^{2}}{2 {σ}^{2}} ) ; & ( 1 ) \\ h ( p , i ) = {\sum }_{q ∈ {Ω}_{p}} w ( p , q ) δ ( {I}_{p} - i ) . & ( 2 )\end{matrix}$$

In which, formula (1) indicates an exponential function with e as the base, where e=2.71828183. It can be understood that, for a grayscale image represented by an 8-bit binary number, there may be up to 2⁸=256 pixel grayscale values in the image. Therefore, I∈{0, 1, 2, . . . , 255}, where the parameters Iₚ and I_{q} represent the gray value of the pixel p and the pixel q, respectively, and σ² represents the noise variance, Ωₚ in formula (2) indicates a two-bit rectangular neighborhood which has the size of k×k and is centered on the pixel p. i is a discrete integer, which has the same value range with Iₚ. δ(.) is a Kroneck function whose independent variables are two integers. If the two independent variables are equal, the output is 1, otherwise it is 0. It can be understood that, the purpose of adjusting the magnitude of the filtering can be achieved by changing the noise power σ². Hence, in this embodiment, a smaller σ² can be selected in the initial filtering process to perform multiple filtering processes, or a larger σ² can be selected to perform one filtering process, which can be set according to actual needs.

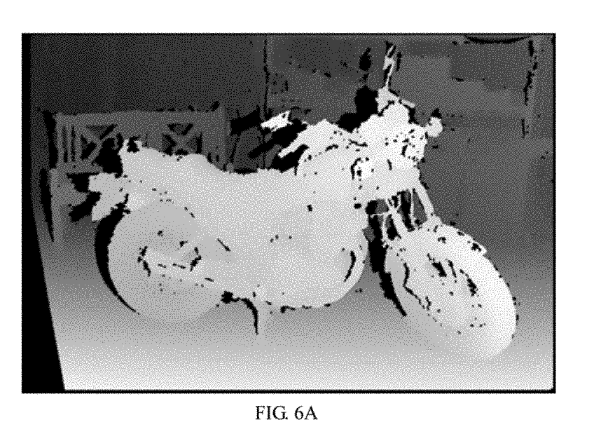

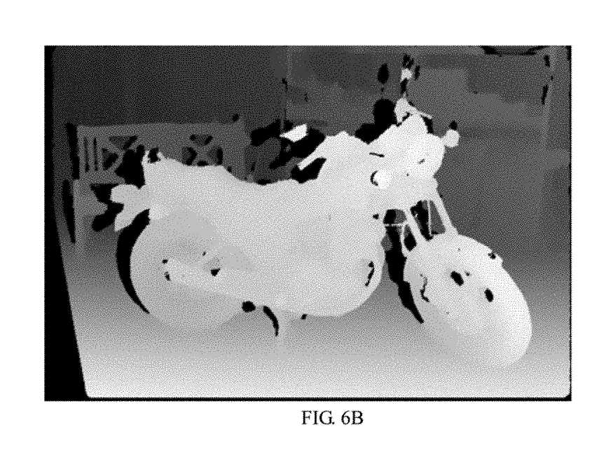

FIG. 6A is a schematic block diagram of the target object before being filtered in step S202 of the image processing method of the fourth embodiment; FIG. 6B is a schematic block diagram of the target object after being filtered in step S202 of the image processing method of the fourth embodiment. As shown in FIG. 6A and FIG. 6B, it can be seen that, after the median filtering is performed, the edges of the image significantly become neat, which obtains satisfactory sharp edge and smooth contours while retaining the important geometric features of the depth image. However, since the amount of the small black dot cavities in the filtered depth map is reduced while the large black dot cavities are still not eliminated, the improvement in overall effects is not significant and therefore needs to be further processed in the subsequent process.

S203: detecting pixel values of pixels in the first depth filter map to obtain first pixels, and forming a black dot cavity area based on the first pixels.

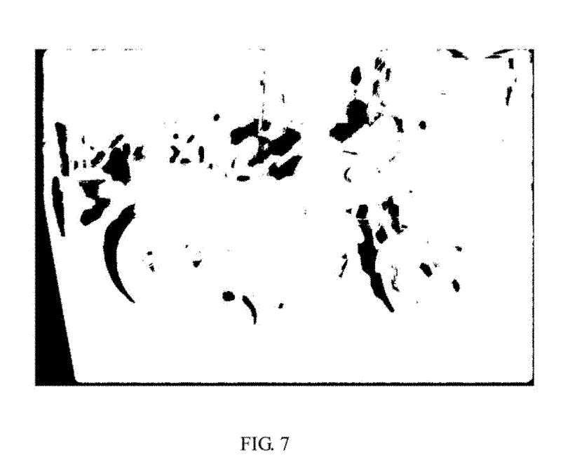

In this embodiment, the detecting method may be a pixel traversing method, that is, a method to inspect each pixel in turn from left to right and from top to bottom, and identifying the pixels with the pixel value of 0 as the first pixels. The black dot cavity area composed of the first pixels described herein can be regarded as the area that needs to be repaired in this embodiment. The depth value of each pixel in the area is made to be within the corresponding depth value standard range by adjusting the depth value of each pixel in the area. FIG. 7 is a schematic block diagram of a black dot cavity area detected by step S203 of the image processing method of the fourth embodiment. As shown in FIG. 7, it is a black dot cavity map found after the detection, that is, the depth map before the repair.

S204: dividing the black dot cavity area into a first black dot cavity area and a second black dot cavity area.

In which, the first black dot cavity area is an area where the target object is located in the depth map, and the second black dot cavity area is an area other than the first black dot cavity area in the depth map.

It should be noted that, the black dot cavity area is generally caused by two types of reasons. The one type is due to the sheltering in the left and right images. Because the offset of the foreground object (which near to the camera) is larger than that of the background object (which away from the camera), a part of the background is sheltered, so that a part of the image content of the background object can only be seen through one camera but not in the other camera, and the black dot cavity area such as the center area of the depth map where the target object is located is generated due to the inability to match when calculating the depth map through a stereo matching algorithm. The other type is due to the difference in the perspective coverage area of the left and the right cameras. Because of the relative positional relationship between the left camera and the right camera, the observed areas are different, and the area around the corresponding depth map has the area which two cameras cannot cover at the same time such as the surrounding border area in the depth map except the area where the target object is located, so that the black dot cavities are generated near the edges, therefore, the black dot cavity area in the depth map may be correspondingly divided according to the above-mentioned causes so as to obtain the first black dot cavity area and the second black dot cavity area.

S205: re-assigning the depth value of each of the first pixels in the first black dot cavity area according to a first preset rule to obtain a first repaired depth map.

In which, the first preset rule is: taking any pixel in the first black dot cavity area as a starting point in the first black dot cavity area, searching for a first reference pixel along at least one direction of the surrounding of the starting point in the first black dot cavity area, comparing the depth values of the first reference pixel which is first found in each direction to obtain a minimum depth value, and assigning the minimum depth value to the starting point in the first black dot cavity area, where the first reference pixel refers to a pixel with the pixel value larger than a first preset value; the first reference pixel refers to a pixel with the pixel value larger than a first preset value.

Furthermore, the first reference pixel may be a pixel whose pixel value is larger than 0.

S206: re-assigning the depth value of each of the first pixels in the second black, dot cavity area according to a second preset rule to obtain a second repaired depth map.

In which, the second preset rule is: searching for at least a second reference pixel along a horizontal direction or a vertical direction by taking any pixel in the second black dot cavity area as a starting point in the second black dot cavity area, calculating an average value of the depth values of the found second reference pixels, and assigning the average value to the starting point in the second black dot cavity area; the second reference pixel refers to a pixel with the pixel value larger than a second preset value.

Furthermore, the second reference pixel may be a pixel whose pixel value is larger than 0.

S207: taking the first repaired depth map and the second repaired depth map as the depth map after repair.

The implementations of steps S204-S207 will be illustrated by a simple example. In the image shown in FIG. 7, the first black dot cavity area is the imaging area where the motorcycle is located, that is, the central area of the image; the second black dot cavity area is a surrounding border area other than the imaging area of the motorcycle, that is, the first row, the last row, the first column, and the last column of the matrix corresponding to the image.

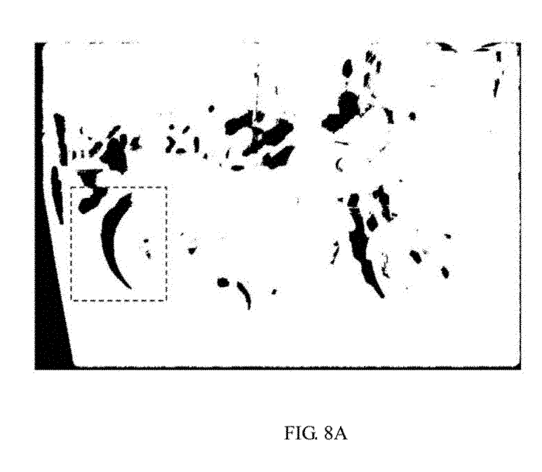

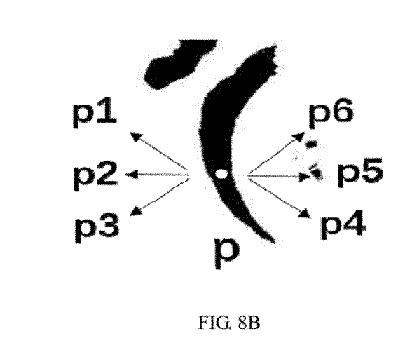

When the pixels in the first black dot cavity area (which has been framed by the dotted line) where the rear wheel of the motorcycle shown in FIG. 8A is located are searched along at least one direction of the surrounding according to the first preset rule, a pixel p to be repaired can be selected arbitrarily and taken as the starting point, and then the first reference pixels that appear for the first lime are searched along six directions including the top left 45°, the left, the lower left 45°, the lower right 45°, the right, the upper right 45° and marked as p1, p2, . . . , and p6. respectively. The depth values at p1, p2, . . . , and p6 are compared one by one. and the smallest non-zero value after the comparison is taken as the depth value of point p for replacement.

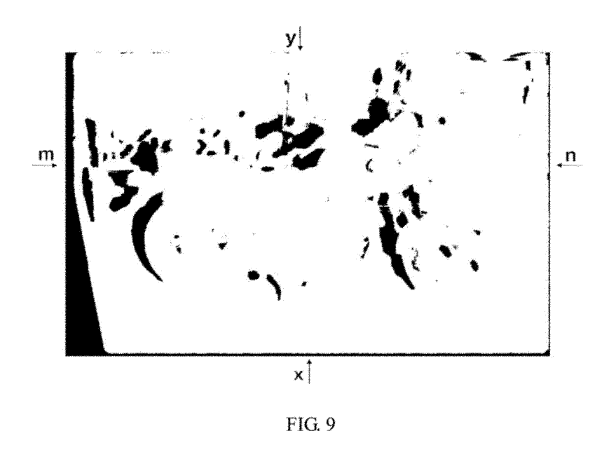

Similarly, when the pixels in the second black dot area other than the first black dot area where the motorcycle shown in FIG. 7 is located are searched in the horizontal or vertical direction according to the second preset rule, three second reference pixels are searched from the pixels in the left and right borders in mn directions shown in FIG. 9, and the average value d̅e̅p̅₁̅ of the depth values of the three reference pixels is calculated and taken as the depth value of the starting point in the second black dot cavity area; and/or three second reference pixels are searched from the pixels in the upper and lower borders in xy directions shown in FIG. 9, and the average value d̅e̅p̅₂̅ of the depth values of the three reference pixels is calculated and taken as the depth value of the starting point in the second black dot cavity area.

It can be understood that, the determination of the boundary may have a blurring problem of boundary areas, and the position of the boundary point may be various, but the distance between each boundary point to be calibrated and the correct boundary point is not too large. Hence, during the calibration process, it only needs to operate in the neighborhood of the boundary point to be calibrated.

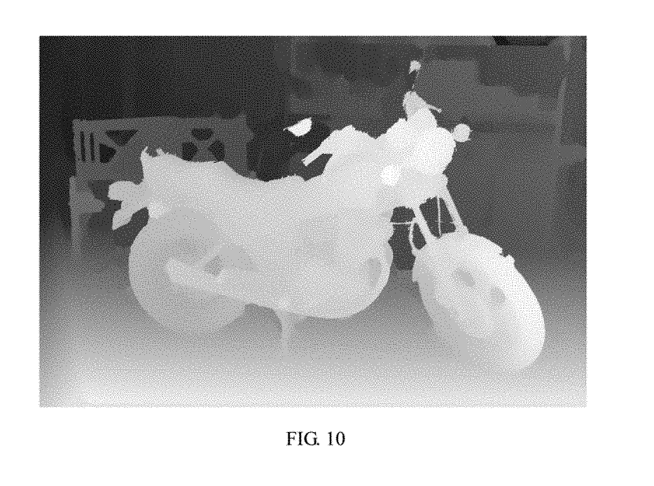

In this embodiment, after repairing FIG. 7 according to the first preset rule and the second preset rule, the depth map as shown in FIG. 10 which is more clear is obtained.

S208: filtering the depth map after repair to obtain a second depth filter map.

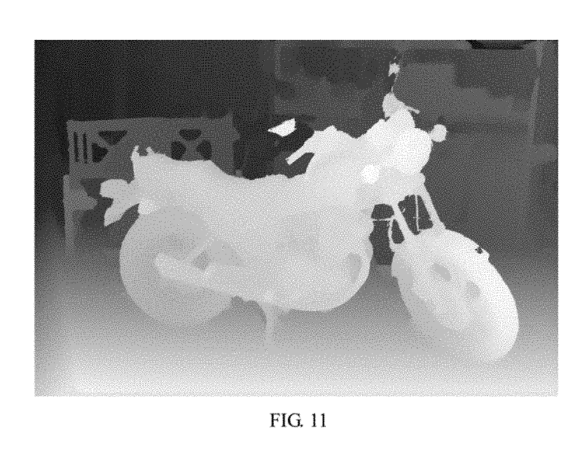

In this embodiment, the secondary filtering is performed on FIG. 10 to achieve the purpose of further refinement, and the final output depth map, that is FIG. 11, is obtained. For details, refer to the related description of step S202, which are not described herein.

In this embodiment, by dividing the black dot cavity area into the first black dot cavity area and the second black dot cavity area and then processing according to the first preset rule and the second preset rule, respectively, the large black dot cavities in the first depth filter map after the initial filtering are repaired, and the purpose of further improving the quality of the depth map is achieved by filtering the repaired depth map again.

Those skilled in the art may clearly understand that, for the convenience and simplicity of description, for the specific operation process of the units and modules in the above-mentioned embodiments, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative modules/units and/or steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed robot apparatus and method may be implemented in other manners. For example, the above-mentioned apparatus embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented image processing method, comprising executing on a processor the steps of:
obtaining a depth map and a color map of a target object in a predetermined scene;
filtering the depth map based on the color map to obtain a first depth filter map;
detecting pixel values of pixels in the first depth filter map to find one or more first pixels with the pixel values less than or equal to a preset value, and forming a black dot cavity area based on the one or more first pixels;
re-assigning a depth value of each of the one or more first pixels in the black dot cavity area according to a preset rule to obtain the depth map after repair; and
filtering the depth map after repair to obtain a second depth filter map.

2. The method of claim 1, wherein the step of filtering the depth map based on the color map to obtain the first depth filter map comprises:
obtaining a pixel matrix of pixels in the color map;
obtaining any pixel in the pixel matrix, setting a matrix window centering on the obtained pixel, and obtaining a median value of gray values of all the pixels in the matrix window; and
assigning the median value to one or more pixels in the depth map corresponding to the position of the obtained pixel to obtain the first depth filter map, wherein the positions of the pixels in the depth map are in one-to-one correspondence with the positions of the pixels in the color map.

3. The method of claim 1, wherein the step of re-assigning the depth value of each of the one or more first pixels in the black dot cavity area according to the preset rule to obtain the depth map after repair comprises:
dividing the black dot cavity area into a first black dot cavity area and a second black dot cavity area;
re-assigning the depth value of each of the one or more first pixels in the first black dot cavity area according to a first preset rule to obtain a first repaired depth map;
re-assigning the depth value of each of the one or more first pixels in the second black dot cavity area according to a second preset rule to obtain a second repaired depth map; and
taking the first repaired depth map and the second repaired depth map as the depth map after repair;
wherein, the first black dot cavity area is an area the target object is located in the depth map, and the second black dot cavity area is an area other than the first black dot cavity area in the depth map.

4. The method of claim 3, wherein the first preset rule is: taking any pixel in the first black dot cavity area as a starting point in the first black dot cavity area, searching for a first reference pixel along at least one direction of the surrounding of the starting point in the first black dot cavity area, comparing the depth values of the first found first reference pixel in each direction to obtain a minimum depth value, and assigning the minimum depth value to the starting point in the first black dot cavity area, wherein the first reference pixel refers to a pixel with the pixel value larger than a first preset value;
wherein the second preset rule is: searching for at least a second reference pixel along a horizontal direction or a vertical direction by taking any pixel in the second black dot cavity area as a starting point in the second black dot cavity area, calculating an average value of the depth values of the found second reference pixels, and assigning the average value to the starting point in the second black dot cavity area, wherein the second reference pixel refers to a pixel with the pixel value larger than a second preset value.

5. The method of claim 1, wherein before the step of obtaining the depth map and the color map of the target object in the predetermined scene comprises:
obtaining the depth map and the color map based on a left view image and a right view image from a camera.

6. An image processing apparatus, comprising:
an obtaining module configured to obtain a depth map and a color map of a target object in a predetermined scene;
a first filtering module configured to filter the depth map based on the color map to obtain a first depth filter map;
a detection module configured to detect pixel values of pixels in the first depth filter map to find one or more first pixels with the pixel values less than or equal to a preset value, and form a black dot cavity area based on the one or more first pixels;
a processing module configured to re-assign a depth value of each of the one or more first pixels in the black dot cavity area according to a preset rule to obtain the depth map after repair; and
a second filtering module configured to filter the depth map after repair to obtain a second depth filter map.

7. The apparatus of claim 6, wherein the first filtering unit comprises:
a first obtaining submodule configured to obtain a pixel matrix of pixels in the color map;
a second obtaining submodule configured to obtain any pixel in the pixel matrix, setting a matrix window centering on the obtained pixel, and obtaining a median value of gray values of all the pixels in the matrix window; and
a processing submodule configured to assign the median value to one or more pixels in the depth map corresponding to the position of the obtained pixel to obtain the first depth filter map, wherein the positions of the pixels in the depth map are in one-to-one correspondence with the positions of the pixels in the color map.

8. The apparatus of claim 6, wherein the processing unit comprises:
a dividing submodule configured to divide the black dot cavity area into a first black dot cavity area and a second black dot cavity area;
a first processing submodule configured to re-assign the depth value of each of the one or more first pixels in the first black dot cavity area according to a first preset rule to obtain a first repaired depth map;
a second processing submodule configured to re-assign the depth value of each of the one or more first pixels in the second black dot cavity area according to a second preset rule to obtain a second repaired depth map;
a merging submodule configured to take the first repaired depth map and the second repaired depth map as the depth map after repair;
wherein, the first black dot cavity area is an area the target object is located in the depth map, and the second black dot cavity area is an area other than the first black dot cavity area in the depth map.

9. The apparatus of claim 8, wherein the first preset rule is: taking any pixel in the first black dot cavity area as a starting point in the first black dot cavity area, searching for a first reference pixel along at least one direction of the surrounding of the starting point in the first black dot cavity area, comparing the depth values of the first found first reference pixel in each direction to obtain a minimum depth value, and assigning the minimum depth value to the starting point in the first black dot cavity area, wherein the first reference pixel refers to a pixel with the pixel value larger than a first preset value;
wherein the second preset rule is: searching for at least a second reference pixel along a horizontal direction or a vertical direction by taking any pixel in the second black dot cavity area as a starting point in the second black dot cavity area, calculating an average value of the depth values of the found second reference pixels, and assigning the average value to the starting point in the second black dot cavity area, wherein the second reference pixel refers to a pixel with the pixel value larger than a second preset value.

10. The apparatus of claim 6, wherein the obtaining module is further configured to: obtain the depth map and the color map based on a left view image and a right view image from a camera.

11. A robot, comprising:
a memory;
one or more processors; and
one or more computer programs stored in the memory and executable on the one or more processors, wherein the one or more computer programs comprise:
instructions for obtaining a depth map and a color map of a target object in a predetermined scene;
instructions for filtering the depth map based on the color map to obtain a first depth filter map;
instructions tor detecting pixel values of pixels in the first depth filter map to find one or more first pixels with the pixel values less than or equal to a preset value, and forming a black dot cavity area based on the one or more first pixels;
instructions for re-assigning a depth value of each of the one or more first pixels in the black dot cavity area according to a preset rule to obtain the depth map after repair; and
instructions for filtering the depth map after repair to obtain a second depth filter map.

12. The robot of claim 11, wherein the instructions for filtering the depth map based on the color map comprises:
instructions for obtaining a pixel matrix of pixels in the color map;
instructions for obtaining any pixel in the pixel matrix, setting a matrix window centering on the obtained pixel, and obtaining a median value of gray values of all the pixels in the matrix window; and
instructions for assigning the median value to one or more pixels in the depth map corresponding to the position of the obtained pixel to obtain the first depth filter map, wherein the positions of the pixels in the depth map are in one-to-one correspondence with the positions of the pixels in the color map.

13. The robot of claim 11, wherein the instructions for re-assigning the depth value of each of the one or more first pixels in the black dot cavity area comprises:
instructions for dividing the black dot cavity area into a first black dot cavity area and a second black dot cavity area;
instructions for re-assigning the depth value of each of the one or more first pixels in the first black dot cavity area according to a first preset rule to obtain a first repaired depth map;
instructions for re-assigning the depth value of each of the one or more first pixels in the second black dot cavity area according to a second preset rule to obtain a second repaired depth map; and
instructions for taking the first repaired depth map and the second repaired depth map as the depth map after repair;
wherein, the first black dot cavity area is an area the target object is located in the depth map, and the second black dot cavity area is an area other than the first black dot cavity area in the depth map.

14. The robot of claim 13, wherein the first preset rule is: taking any pixel in the first black dot cavity area as a starting point in the first black dot cavity area, searching for a first reference pixel along at least one direction of the surrounding of the starting point in the first black dot cavity area, comparing the depth values of the first found first reference pixel in each direction to obtain a minimum depth value, and assigning the minimum depth value to the starting point in the first black dot cavity area, wherein the first reference pixel refers to a pixel with the pixel value larger than a first preset value;
wherein the second preset rule is: searching for at least a second reference pixel along a horizontal direction or a vertical direction by taking any pixel in the second black dot cavity area as a starting point in the second black dot cavity area, calculating an average value of the depth values of the found second reference pixels, and assigning the average value to the starting point in the second black dot cavity area, wherein the second reference pixel refers to a pixel with the pixel value larger than a second preset value.

15. The robot of claim 11, wherein the robot further comprises a camera, and the one or more computer programs further comprise:
instructions for obtaining the depth map and the color map based on a left view image and a right view image from the camera.
